(19) United States
(12) Patent Application Publication
(10) Pub. No.: US 2026/0087452 A1
(43) Pub. Date: Mar. 26, 2026

(54) METHOD FOR CREATING CONTENT THROUGH AN ONLINE COLLABORATIVE SYSTEM

(71) Applicant: Wizard Media Inc. d/b/a Wordbrew, Tampa, FL (US)

(72) Inventor: Georgia Austin, Tampa, FL (US)

(73) Assignee: Wizard Media Inc. d/b/a Wordbrew, Tampa, FL (US)

(21) Appl. No.: 18/898,215

(22) Filed: Sep. 26, 2024

(51) Int. Cl. G06Q 10/101

(52) U.S. Cl. CPC G06Q 10/101

(57) ABSTRACT

A method for creating content through an online collaborative system is disclosed. The method involves receiving a set of inputs from one or more data sources related to the content and integrating these inputs as context into a language model prompt within an expert collaboration platform. The context is utilized by the platform to create content. The method facilitates real-time collaboration, allowing to turn multimedia insights into structured content outputs quickly. Based on the integrated context and brand-specific data, structured content is generated. This method enhances the uniqueness, accuracy, and relevance of the final content by leveraging diverse data sources and real-time collaborative input, making it suitable for generating various structured outputs like marketing materials and business documents.

### FIELD

The present invention relates to data processing systems and more particularly to the system and method for creating content.

### BACKGROUND

The rise of artificial intelligence (AI) has significantly transformed the way content is generated, with AI-driven content creation systems becoming widely used across industries. These systems often rely on large datasets of existing user-generated content to produce dynamic text, images, and other media. However, this reliance on pre-existing data introduces significant drawbacks in terms of creativity, uniqueness, and accuracy. Because these systems draw from pre-established content, the outputs tend to be repetitive, lacking originality and failing to offer novel insights or perspectives.

One of the primary disadvantages of existing AI-based content creation systems is their inability to effectively incorporate or preserve the distinct perspectives of individual experts. In systems where multiple contributors or sources are involved, the dynamics of group consensus or collaborative processes can result in homogenized content that is influenced by dominant voices or trends. This often leads to biased or one-sided content, reducing the diversity of thought and potentially skewing the accuracy of the information presented. Such group dynamics tend to drown out unique or minority expert perspectives, which may otherwise provide critical insights.

Moreover, existing systems struggle to properly assess and filter content that may be outdated, inaccurate, or irrelevant. These systems frequently fail to detect and eliminate text that should not be propagated, leading to the continued dissemination of invalid or misleading information. The lack of an intelligent editing mechanism that can distinguish between valuable content and erroneous information further reduces the overall quality and credibility of the generated content.

Additionally, current tools do not offer effective platforms for multiple authors or experts to collaborate in real-time. While some systems allow for the input of various contributors, they generally lack a structured environment where experts can simultaneously collaborate, edit, and refine content. This not only affects the engagement and productivity of the authors but also hinders the potential for more dynamic and well-rounded content creation. The absence of such collaborative features limits the uniqueness and engagement level of the content produced, resulting in information that is less compelling and relevant to users.

In view of these shortcomings, there is a critical need for a novel system and method of AI content creation that addresses these limitations. Such a system should enhance the uniqueness, creativity, and accuracy of the content generated, while ensuring the preservation of expert perspectives. The system should also incorporate mechanisms to validate and edit content dynamically, eliminating invalid or irrelevant information. Further, it should provide a collaborative platform that enables multiple experts to work together in real-time, thus increasing engagement, productivity, and the overall quality of the content.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for creating content is disclosed. The system includes a data collection module, a content validation module, an editing platform, an output module and a repository. The various modules of the system and their operation are explained hereinbelow. The data collection module receives a set of inputs from one or more data sources associated with the content. Example of the one or more data sources include inputs received from the one or more collaborators and existing online data such as online blogs, internet websites, published research articles, online reviews and the like. The data collection module is further configured to search for the one or more collaborators having an expertise on the content, collect one or more inputs from the one or more collaborators at a plurality of time instances, and store the one or more inputs into a queue until all the one or more inputs is collected, where the one or more inputs form part of the set of inputs. The one or more inputs can be collected in the form of a voice memo, video, audio, short text, survey, chat message /d/ or a questionnaire. The one or more inputs can include unique comments, opinions, and insights received from the one or more collaborators.

The content validation module is configured to eliminate invalid data from the set of inputs. As a result, an erroneous or invalid content is prevented from propagating forward. The editing platform is further configured to integrate the set of inputs in the form of a context into a language model prompt, where the context is used for creating the content. The editing platform also facilitates the one or more collaborators to edit the content in real-time for creating a unique draft. In an embodiment, the editing platform is configured to track changes made by each collaborator, maintain a plurality of versions of the created content, and facilitate a user to revert to a previous version of the created content.

The output module is configured to create a structured content based on the context and brand data. The structured content includes one or more marketing materials, blogs, white papers, case studies, shareholder letters, contracts, business collaterals research articles, and internal documents. The brand data that is used for creating the structured content can include a plurality of rule for punctuation, grammar, stop words, banned terms, font, style, size of text and editing style parameters used for creating the content. The brand data can be stored within the repository and can be defined or modified by a user.

According to an example embodiment, a method for creating content by an online collaborative system is disclosed. The method includes receiving a set of inputs from one or more data sources associated with the content. In order to receive the set of inputs, the system receives one or more inputs from one or more collaborators and remaining inputs from existing online data such as blogs, online reviews, website articles and the like. To receive the one or more inputs from the one or more collaborators, the method includes searching for the one or more collaborators, where a collaborate is a subject-matter expert or has an expertise on the content. The one or more inputs can be in the form voice memos, video, audio, short text, surveys, chat messages and questionnaires.

Alternatively, the method includes creating suggestions for relevant collaborators based on the content, using one or more embedded models and a vector database. The method further includes collecting one or more inputs from the one or more collaborators and the relevant collaborators. Typically, the one or more inputs can be received at one or more time instances, as each collaborator can provide an input at a time independent of another collaborator. The one or more inputs are stored temporarily in a waiting module or a queue, until all the one or more inputs are received before providing the one or more inputs to the editing platform. The one or more inputs form part of the set of inputs provided to the editing platform.

Further, the method includes identifying invalid data present in the set of inputs and eliminating the invalid data prior to integrating the set of inputs into the language model prompt. The method further includes integrating the set of inputs in a form of context into a language model prompt of an editing platform, wherein the context is used by the editing platform for creating the content. Further, the method includes facilitating one or more users to collaborate and edit the content in real-time during the creation of the content. The method further includes creating a structured content based on the context and brand data. The brand data comprises a plurality of rules for punctuation, grammar, stop words, banned terms, font, style, size of text and editing style parameters used for creating the content, stored in a repository. The structured content can include marketing materials, blogs, white papers, case studies, shareholder letters, contracts, business collaterals, research articles, or internal documents.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of an environment depicting an online collaborative system for creating content, according to an example embodiment;

FIG. 2 is a block diagram of the online collaborative system of FIG. 1, according to an example embodiment;

FIG. 3 is a flow diagram illustrating a process of creating content, according to existing prior art;

FIG. 4 is a flow diagram illustrating a process of creating content by an online collaborative system, according to an example embodiment;

FIG. 5 is a flowchart illustrating a method of creating content by an online collaborative system, according to an example embodiment;

FIGS. 6A-6B is a flowchart illustrating a method of creating content by an online collaborative system, according to an example embodiment; and

FIG. 7 is a block diagram of an embodiment of a computing device in which the modules of the system of FIG. 1, described herein, are implemented.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Similarly, like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any, and all combinations of one or more of the associated listed items. The phrase “at least one of”has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skills in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in ‘addition to the orientation depicted in the figures. For example, if the device in the figures is turned over, elements described as “below”, or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

At least one example embodiment is generally directed to techniques for creating content in a collaborative manner using expert opinions. In particular, the embodiments disclose techniques relating to training a generative artificial intelligence machine learning model to produce a structured content based on a plurality of inputs received from one or more collaborators or experts in real-time and from a plurality of digital resources. Detailed work is explained herein below with reference to the figures.

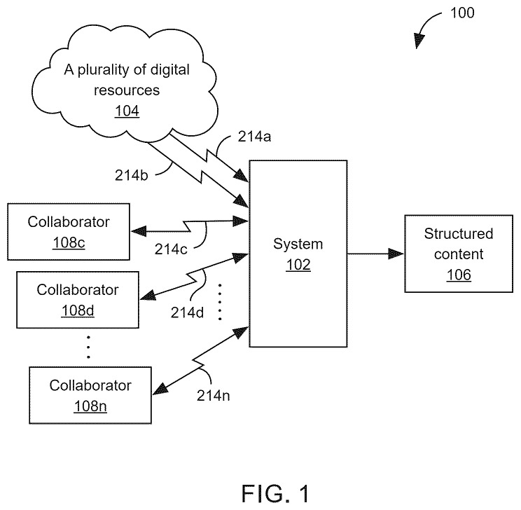

FIG. 1 illustrates an environment (100) within which a system (102) also referred to as an online collaborative system (102) is operated to create a structured content (106). The environment (100) includes one or more data sources such as digital resources (104), and one or more collaborators (108c-108n), communicatively coupled to the system (102). Examples of the plurality of digital resources (104) include but are not limited to, the data available on the Internet, Google Drive, cloud-storage, and other cloud-based resources. Dropbox, OneDrive, Amazon Web Services (AWS), iCloud, GitHub, Box, Slack, Google Cloud Platform (GCP), and Zoom are other examples of digital resources that can be couped to the system (102). Example, of the one or more collaborators (108a-108n) include experts or humans that have expertise on the subject matter related to the content. For example, if the content is dairy products, then the experts include dairy technologists, food scientists, dairy nutritionists, veterinarians, dairy farmers, dieticians, agronomists, regulatory experts and the like. In some cases an expert is just regular people who have experience with a topic, thing, or place who can contribute. Sometimes a system user just want the insights or opinions of average people.

A set of inputs (214a-214n) are received from the one or more data sources and provided to the system (102). For example, one or more inputs (214c-214n) are received from the one or more collaborators (108c-108n). The one or more inputs (214c-214n) are not crowdsourced from general public but are curated in real-time from one or more industry experts or collaborators (108c-108n). Examples of the one or more inputs (214a-214n) include insights, opinions, views, knowledge, and perspectives. Remaining inputs (214a-21b) are received from the plurality of digital resources (104). Examples of the remaining inputs (214a-214b) can include published articles online, research works, blogs, general opinions and views of public, chat messages, and the like.

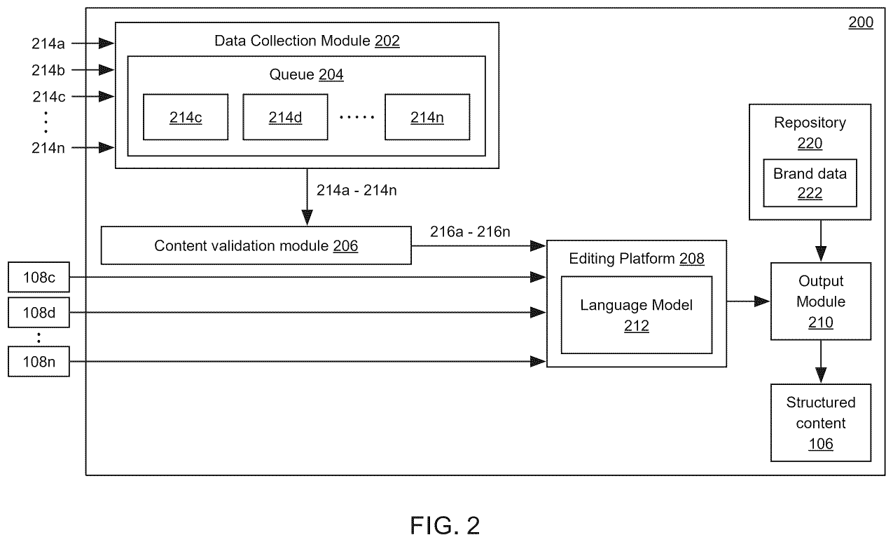

The system (102) can be hosted on the cloud or an a server. Upon receiving the set of inputs (214a-214n), the system (102) creates the structured content (106). The online collaborative system (102) is a digital platform designed to facilitate teamwork and communication among individuals or groups working on shared tasks or projects, regardless of their physical location. These systems typically leverage cloud technology to allow real-time collaboration, where multiple users can simultaneously access, edit, and share documents, data, or other resources for creating the structured content (106). Further explanation of the system (102) is explained with reference to FIG. 2.

FIG. 2 is a block diagram of the system (200) or system (102). The system (200) includes a data collection module (202), a content validation module (206), an editing platform (208) and an output module (210). The data collection module (202) receives the set of inputs (214a-214n) and stores the one or more inputs (214c-214n) as received from the one or more collaborators (108c-108n) temporarily in a queue (204) until all the one or more inputs (214c-214n) are received. The data collection module (202) searches for the one or more collaborators (108c-108n) having an expertise on the content and collects the one or more inputs (214c-214n) from the one or more collaborators (108c-108n) at a plurality of time instances. For example, each collaborator (e.g. 108c) may provide an input (214c) at a time distinct than when another collaborator (e.g. 108d) provides an input (e.g. 214d). Hence, while the input (214c) from the collaborator (108c) can be received by the data collection module (202) at time instance T1, the input (214d) from the collaborator (108d) can be received at another time instance T2. The data collection module (202) further stores the one or more inputs (214c-214n) into the queue (204). Typically, the one or more inputs (214c-214n) form part of the set of inputs (214a-214n) used for creating the structured content (106). Examples of the one or more inputs (214c-214n) include one or more of a voice memo, video, audio, short text, survey, chat message and questionnaire.

The content validation module (206) receives the set of inputs (214a-214n), from the data collection module (202), and eliminates invalid data from the set of inputs (214a-214n), to provide a set of valid data (216a-216n). The content validation module (206) is a machine learning model trained to identify invalid data based on the context of the content. This prevents erroneous and invalid data from propagating further through the system (200).

The content validation module (206) initially preprocesses the input, where text is tokenized and transformed into contextual embeddings using models like BERT (Bidirectional Encoder Representations from Transformers). The contextual embeddings help capture the meaning of words and phrases in relation to their surrounding context. For domain-specific content (such as legal, financial, or healthcare texts), custom rules or ontologies can be incorporated to ensure that the content validation module (206) understands and applies industry-relevant knowledge. In an embodiment, the content validation module (206) includes an anomaly detection model like Isolation Forest or Autoencoder that is used to flag outliers and detect invalid structured data (such as numbers or dates that don't conform to expected patterns).

The content validation module (206) is trained on a labelled dataset where valid and invalid content is classified based on context. The BERT-based model identifies invalid text by analysing the context, while the anomaly detection model flags unusual patterns in structured data. The outputs from these models are combined in a decision layer that assigns a validity score to each data point, determining whether the content should be accepted or removed. By continuously learning from user feedback and evolving datasets, the module can adapt to improve its accuracy over time. This hybrid approach enables it to effectively validate data in various industries and content types, providing a robust and scalable solution for real-time content validation.

The editing platform (208) includes a language model (208). The editing platform (208) integrates the set of valid inputs (216a-216n) in the form of a context into a prompt of the language model (212), where the context is used for creating the content. The language model (212) is a machine learning model trained to compose or collaborate content from the plurality of data sources, along with expert insights received in real-time, and provide meaningful data unique to the content. The editing platform (208) also facilitates the one or more collaborators (108c-108n) to collaborate and edit the content in real-time.

In an embodiment, the editing platform (208) is also configured to track changes made by each collaborator, maintain a plurality of versions of the created content, and facilitate a user to revert to a previous version of the created content. In other words, the editing platform (208) is designed to manage collaborative content creation by offering robust version control features. As collaborators work on the content, the platform tracks and logs the changes made by each user, maintaining a detailed record of who made what changes and when. This ensures full transparency and accountability during the collaborative process. Additionally, the platform stores multiple versions of the content, allowing it to maintain a history of edits over time. A key feature of this system is that it allows users to easily revert to a previous version of the content. This means if an unwanted change is made or if a mistake occurs, the user can restore the content to a previous state without losing any earlier work. These capabilities ensure both flexibility and control in managing the content development process.

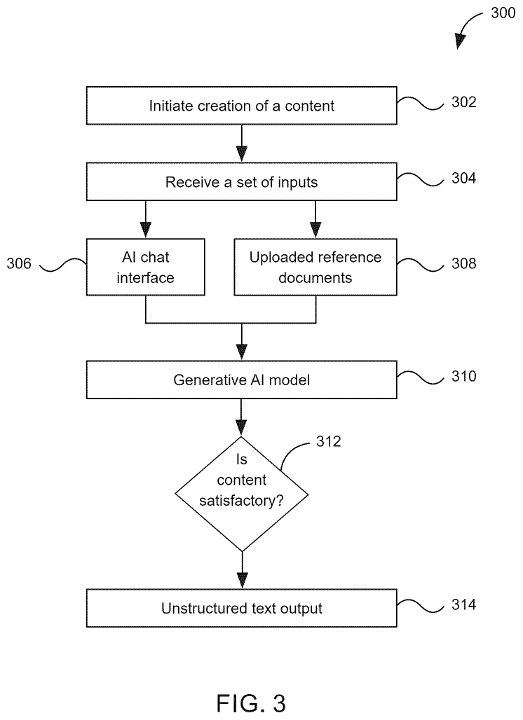

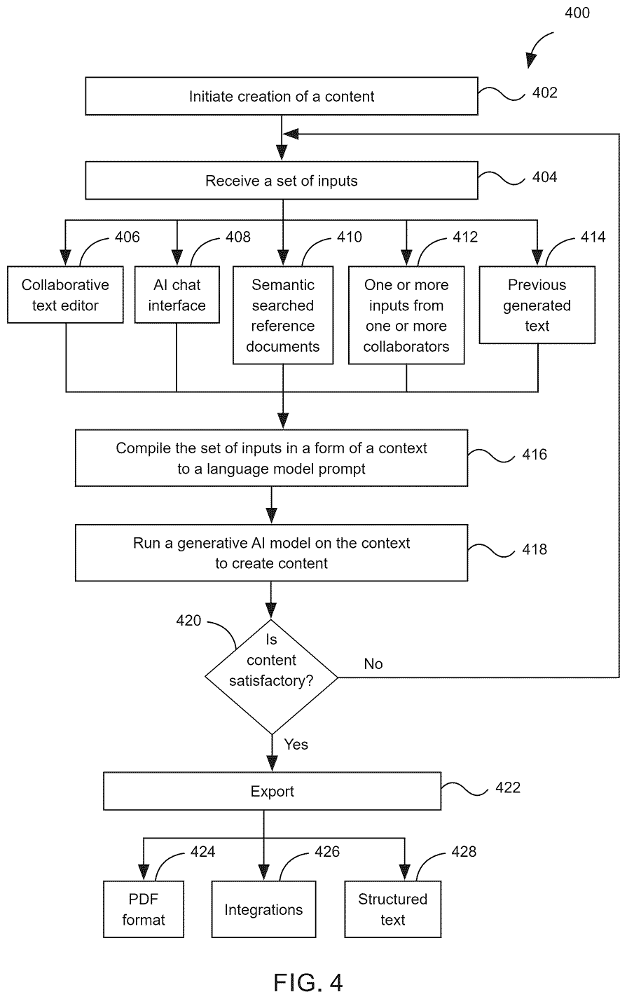

The collaborated content is provided to the output module (210) that is configured to create the structured content (106) based on the context and brand data. The structured content (106) can be any kind of written content whether marketing material or internal collateral. Typical examples include marketing materials, blogs, white papers, case studies, shareholder letters, contracts, business collaterals, research articles, and internal documents. The output module (210) creates the structured content (106) based on the context identified and the brand data (222). The brand data (222) typically includes a plurality of rules for punctuation, grammar, stop words, banned terms, font, style, size of text and editing style parameters used for creating the content. The brand data (222) can be user defined and is stored in a repository (220). A process of creating the content is further explained with reference to FIG. 3 and FIG. 4.

FIG. 3 is a flow diagram 300 illustrating a process of creating content according to existing prior systems. As shown, at 302 a process of creating the content is initiated by a user. At 304, a set of inputs required for the content is received by a prior art system. The set of inputs can be received via an Artificial intelligence (AI) chat interface at 306, or by a plurality of uploaded reference documents or digital references, at 308.

Further, at 310, a generative AI module is run on the set of inputs to create the content. At 312, user feedback on the content is taken. If the content is satisfactory, an unstructured text is provided as an output containing the content, at 314. However, in case the content is found to be unsatisfactory, then the process flows back to 304, to receive additional set of inputs, for recreating the content. A drawback of this prior art system is it only takes into account, inputs received from an AI chat interface or digital references. Hence, the uniqueness of the content is limited. The process followed in the present disclosure is finer and extrapolatory as discussed further with respect to FIG. 4.

FIG. 4 is a flow diagram 400 illustrating a process of creating content by an online collaborative system, as disclosed in FIG. 2. At 402, a process of creating content is initiated. At 404, a set of inputs is received. The set of inputs is received from a collaborative text editor at 406, an artificial intelligence (AI) chat interface at 408, a plurality of semantically searched reference documents at 410, one or more inputs or insights from one or more collaborators or experts at 412, and from previously generated text on the same content at 414.

At 416, the set of inputs is compiled in the form of a context and provided to a language model prompt. The language model is a machine learning model, trained to collaborate content at a plurality of intervals to create unique content.

At 418, a generative AI model or the language model is run on the set of inputs and the context to create the content.

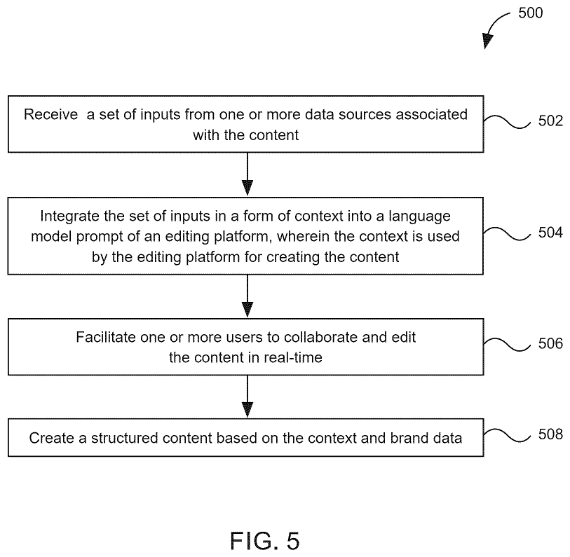

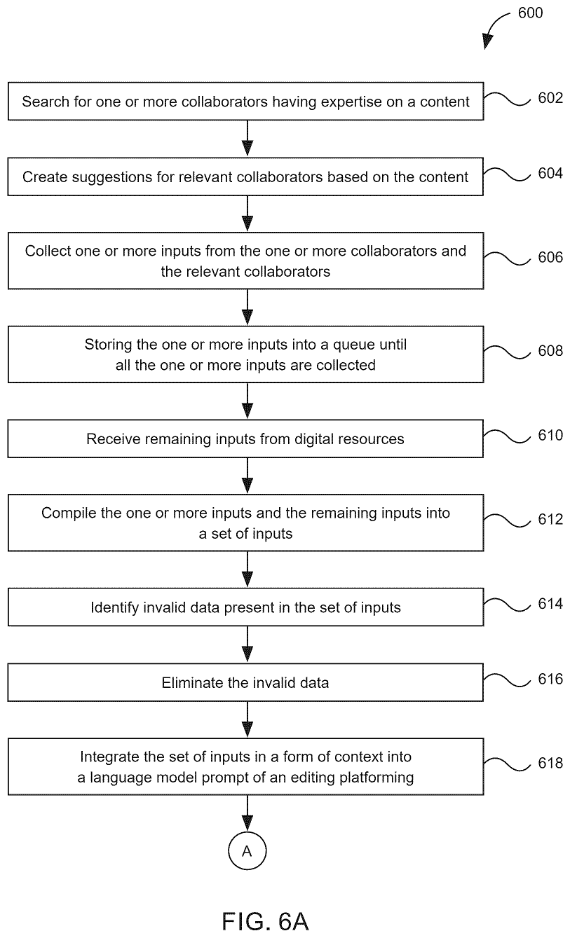

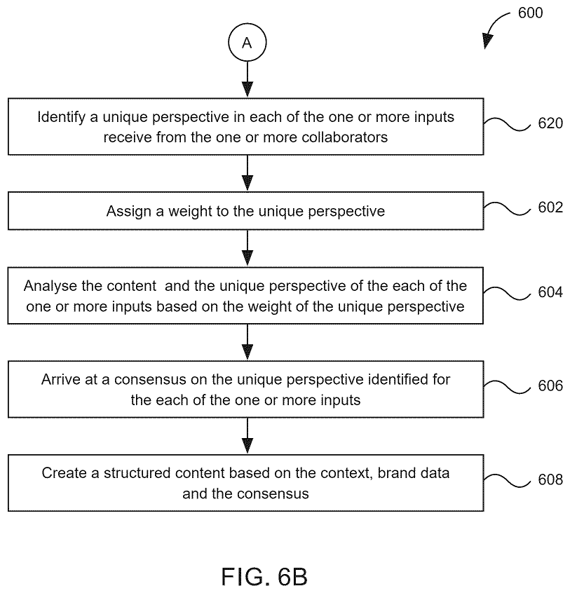

At 420, a check is made on the content to determine if it is found satisfactory by a user. In case the content is found satisfactory, the content is exported at 422, into a plurality of structured formats. For instance, at 424, the content is exported in a pdf file format. Further, at 426, the content is exported in the form of integrations, and at 428 the content is exported in the form of a structured text. However, in case the content is found to be unsatisfactory, then the process flows back to 404, where further set of inputs are procured for recreating or updating the content. The feedback is used to train the generative AI model or the language model. The process is further explained with reference to a method flowchart in FIG. 5 and FIG. 6.

FIG. 5 is a flowchart 500 illustrating a method for creating content by an online collaborative system, according to an example embodiment.

At 502, a set of inputs is received from one or more data sources associated with the content. The set of inputs can include digital resources or insights, opinions and comments provided by experts or collaborators on the subject matter associated with the content.

At 504, the set of inputs is integrated in the form of a context into a language model prompt of an editing platform, wherein the context is used by the editing platform for creating the content.

At 506, one or more users to collaborate and edit the content in real-time is facilitated. Typically, a plurality of collaborators can edit the content at various times independently of the other collaborators. The editing platform is trained to synchronize and account for all the edits made by the collaborators and is also trained to select appropriate edits and perspectives provided for the content.

At 508, a structured content based on the context fed to the language model prompt and based on brand data is created. The structured content includes marketing materials, blogs, white papers, case studies, shareholder letters, contracts, business collaterals, research articles, or internal documents. The language model prompt hereinafter referred to as a model is a machine learning model trained to create content based on real-time data. The model is trained to identify a unique perspective in an input of a collaborator, assigning a weight to the unique perspective based on historical data associated with the content, previous inputs received from the collaborator, and unique perspectives identified in remaining inputs received from remaining collaborators. The model is further developed to analyze the content and the unique perspective of the each of the one or more inputs based on the weight of the unique perspective. Further, the model arrives at a consensus on the unique perspective identified for the each of the one or more inputs. The consensus is independent of a general consensus existing on the content in public domain. The consensus is used for creating the structured content.

FIGS. 6A-6B illustrated a flowchart 600 of a method for creating content by an online collaborative system hereinafter referred to as a system, according to an example embodiment;

At 602, one or more collaborators having expertise in the content are searched by the system.

At 604, suggestions for relevant collaborators are provided based on the content. Typically, the system can recommend relevant collaborators for the content based on historical data stored in a repository of the system.

At 606, one or more inputs from the one or more collaborators and the relevant collaborators are collected. The one or more inputs can include insights, perspectives, and opinions. In an example, an input can be a voice memo, which can be converted into text. Further, an input can be a video submission, from which text is extracted and used for content creation. Another input can be a short survey that collects targeted insights through questionnaires. The answers are converted into qualitative or quantitative outputs. Further, by accepting various media types, the platform accommodates diverse ways of capturing expert insights, making the process flexible and inclusive.

At 608, the one or more inputs are stored in a queue until all the one or more inputs are collected or received.

At 610, remaining inputs from digital resources are received. Digital resources may include published articles, blogs, and such content present on the Internet or any other cloud storage network.

At 612, the one or more inputs and the remaining inputs are compiled into a set of inputs.

At 614, invalid data present in the set of inputs are identified. The invalid data is eliminated from the set of inputs.

At 616, the set of inputs are integrated in a form of context into a language model prompt of an editing platform.

At 618, a unique perspective in each of the one or more inputs received from the one or more collaborators is identified.

At 620, a weight is assigned to the unique perspective in the each of the one or more inputs. This weighting process is crucial because it determines a relative importance or influence of each input in the created content. The system uses a combination of predefined criteria defined within the language model to assign weights. For example, perspectives provided by experts with higher credibility or more relevant experience may receive a higher weight compared to inputs from less experienced contributors.

Additionally, the system may evaluate the relevance of the perspective to the specific content being created. Inputs that align more closely with the topic or context may be given a higher weight. By assigning these weights, the system can balance the different inputs and ensure that the most valuable and relevant contributions have the greatest influence on the final output.

This process of identifying and weighting unique perspectives serves multiple purposes. Firstly, it ensures that the final content is enriched by diverse, well-considered viewpoints rather than being skewed by redundant or less relevant inputs. Secondly by weighing perspectives, the system gives more prominence to the most useful and insightful contributions, thereby improving the overall quality of the content. Further, this permits creating more personalized or contextually relevant content by prioritizing perspectives that add the most value in a specific scenario. In essence, these steps allow the system to intelligently manage collaborative inputs, ensuring that the final content reflects the most unique, accurate, and relevant perspectives provided by the contributors.

At 622, content and the unique perspective of the each of the one or more inputs is analyzed based on the weight of the unique perspective. This analysis is based on the weights that were previously assigned to each perspective in the earlier step. The system evaluates both the content and the unique insights offered by each input to determine how much influence they should have in shaping the final output. By using the assigned weights, the system ensures that perspectives deemed more relevant, credible, or valuable carry greater influence in the content creation process.

For instance, if a particular collaborator's input is more closely aligned with the topic, or if their expertise in the subject matter is stronger, the system will give that input more weight, ensuring that their contribution has a larger impact on the final product. This weighted analysis ensures that the content reflects the most important and relevant insights while still incorporating diverse viewpoints. Ultimately, this process creates a more refined, accurate, and contextually relevant piece of content, as the system intelligently balances the varying contributions based on their weighted significance.

At 624, a consensus on the unique perspective identified for the each of the one or more inputs arrived. It is to be noted that the consensus is different and not influenced by a general consensus of the public on the content. This brings the uniqueness to the content creation process.

At 626, a structured content is created based on the context, brand data and consensus so arrived at.

The disclosed system and method offer various advantages over existing content creation systems. Firstly, by incorporating the one or more inputs from experts, first-party insights are used for content creation instead of existing user-generated content. As a result, uniqueness, credibility and accuracy of the information is increased. Further, by using a semantic search implemented with embedded models and vector database, relevant collaborators for the content are identified by the system. This further enhances the accuracy of the content created.

The disclosure offers significant advantages over traditional content creation systems by integrating expert inputs and advanced technological features. One of the primary benefits is the enhancement of the uniqueness and credibility of the content. Instead of relying on user-generated content, which can often be repetitive or inaccurate, the system incorporates insights from experts and first-party sources. This ensures that the information is original and authoritative, greatly reducing the risk of duplicating existing content or spreading misinformation.

Another major advantage is the improvement in the accuracy of the content. By drawing on expert knowledge and specialized inputs, the system ensures that the information produced is precise and reliable. In addition, the patent introduces a sophisticated semantic search mechanism that uses embedded models and a vector database. This enables the system to conduct context-aware searches that go beyond simple keyword matching. As a result, the content generated is more aligned with the specific subject matter, enhancing its overall relevance and quality.

Furthermore, the system excels in identifying the most relevant collaborators for content creation. By leveraging its semantic search capabilities, it ensures that individuals with the appropriate expertise are involved in the process. This targeted collaboration contributes to the production of high-quality, accurate content. Together, these features create a more efficient and advanced content creation system, delivering outputs that are not only accurate and credible but also produced by the most suitable experts in the field.

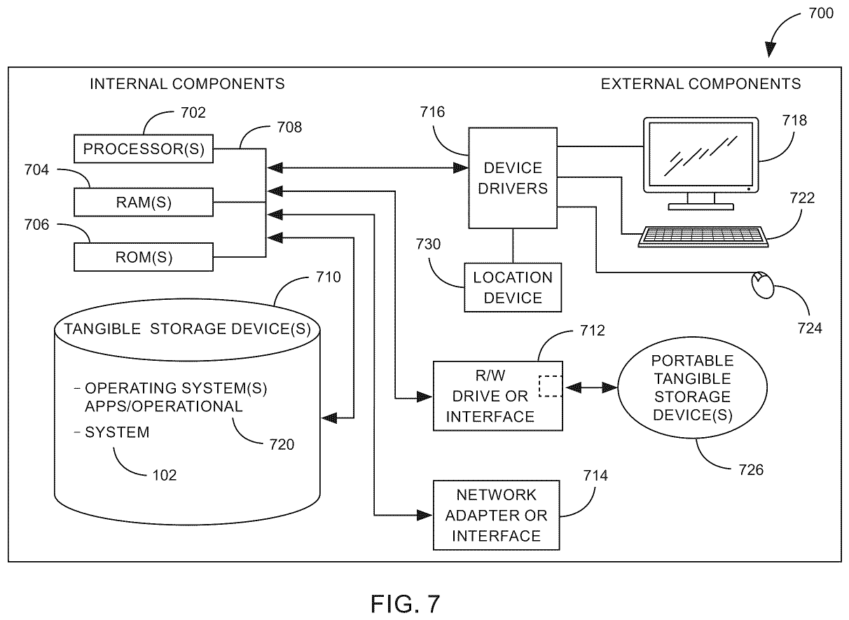

FIG. 7 is a block diagram of an embodiment of a computing device 700 in which the modules of the system 102 of FIG. 1, described herein, are implemented.

The modules of the system 100 described herein are implemented in computing devices. The computing device 700 includes one or more processors 702, one or more computer-readable RAMs 704 and one or more computer-readable ROMs 706 on one or more buses 708. Further, computing device 700 includes a tangible storage device 710 that may be used to execute operating systems 720 and the system 102. The various modules of the system 102 may be stored in tangible storage device 710. Both the operating system 720 and the system 102 are executed by processor 702 via one or more respective RAMs 704 (which typically include cache memory). The execution of the operating system 720 and/or the system 100 by the processor 702, configures the processor 702 as a special purpose processor configured to carry out the functionalities of the operation system 720 and/or the system 102 as described above.

Examples of storage devices 710 include semiconductor storage devices such as ROM, EPROM, flash memory or any other computer-readable tangible storage device that may store a computer program and digital information.

Computing devices also include a R/W drive or interface 714 to read from and write to one or more portable computer-readable tangible storage devices 728 such as a CD-ROM, DVD, memory stick or semiconductor storage device. Further, network adapters or interfaces 712 such as a TCP/IP adapter cards, wireless Wi-Fi interface cards, or 3G or 4G wireless interface cards or other wired or wireless communication links are also included in computing device.

In one example embodiment, the system 102 may be stored in tangible storage device 710 and may be downloaded from an external computer via a network (for example, the Internet, a local area network or other, wide area network) and network adapter or interface 712.

Computing device further includes device drivers 716 to interface with input and output devices. The input and output devices may include a computer display monitor 718, a keyboard 724, a keypad, a touch screen, a computer mouse 726, and/or some other suitable input device.

The advantages of the present invention are a stable list of web landmarks are maintained. The disclosed method and system enhance the accuracy and efficiency of geolocation services. The disclosed system incorporates several innovative features, including an outlier detection mechanism utilizing latency data and density-based clustering to identify and eliminate landmarks with inaccurate metadata. Furthermore, the utilization of DBSCAN clustering efficiently groups landmarks within small areas, reducing redundancy and improving overall system efficiency. Time-series data collection and aggregation techniques with optimized storage and retrieval enable continuous assessment of landmark performance, surpassing conventional single-point measurements. Moreover, a weighted scoring system is introduced, evaluating landmarks based on multiple factors such as network latency, stability, reliability, and geographical diversity. Additionally, dynamic landmark density adjustment mechanisms, driven by a PID controller, optimize landmark distribution based on real-time performance and user demand. Network speed estimation techniques, including the Haversine formula and connection type classification, prioritize landmarks with faster and more reliable connections. An adaptive algorithm, utilizing reinforcement learning, dynamically adjusts landmark selection criteria based on region-specific challenges and historical performance data, ensuring optimal geolocation performance across diverse regions. Hence, the disclosed system and method provide responsiveness to regional differences, which are not provided by existing state of art technologies.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other examples features of example embodiments may be embodied in the form of an apparatus, method, system, computer program, tangible computer readable medium and tangible computer program product. For example, the aforementioned methods may be embodied in the form of a system or device, including, but not limited to, any of the structures for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device's main body or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include, but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

1. A system for content creation, the system comprising:
one or more processors and at least one non-transitory memory storing executable instructions that, when executed by the one or more processors, cause the one or more processors to implement a data-collection process configured to:
receive a plurality of inputs associated with content creation from (i) a plurality of remote collaborator computing devices and (ii) one or more digital data sources;
store collaborator-provided inputs received at different time instances in an asynchronous input queue data structure until a completion condition is satisfied;
execute an input-validation process, prior to any language-model inference, that identifies and programmatically removes invalid input data using at least one trained machine-learning classifier, thereby preventing propagation of erroneous input into downstream language-model prompts;
execute a prompt-construction process that generates a structured language-model prompt by compiling validated collaborator inputs, contextual metadata, and previously generated content into a bounded prompt representation that constrains inference of a generative language model;
execute a real-time collaborative editing process that synchronizes concurrent edits from multiple collaborator computing devices and maintains versioned content states in memory;
execute a structured-output generation process that applies stored brand-rule constraints. including at least grammar rules, banned-term rules, and formatting rules, to output generated by the generative language model; and
a persistent data store storing the brand-rule constraints and collaboration metadata,
wherein the system improves computational content-generation accuracy and reduces language-model hallucination by eliminating invalid inputs prior to language-model inference and by constraining the generative language model using the structured prompt representation and stored brand-rule constraints.

2. The system of claim 1, wherein the processor is further configured to:
search for the one or more collaborators having an expertise on the content;
collect one or more inputs from the one or more collaborators at a plurality of time instances; and
store the one or more inputs into a queue until all the one or more inputs is collected, wherein the one or more inputs form part of the set of inputs.

3. The system of claim 1, wherein the one or more inputs are collected in a form of one or more of a voice memo, video, audio, short text, survey, chat message, and questionnaire.

4. The system of claim 1, wherein the one or more inputs comprises one or more of unique comments, opinions and insights received from the one or more collaborators.

5. The system of claim 1, wherein the one or more data sources comprises inputs received from the one or more collaborators, and a plurality of digital resources.

6. The system of claim 1, wherein the structured content comprises one or more marketing materials, blogs, white papers, case studies, shareholder letters, contracts, business collaterals, research articles, and internal documents.

7. The system of claim 1, wherein the editing platform is further configured to:
track changes made by each collaborator;
maintain a plurality of versions of the created content; and
facilitate a user to revert to a previous version of the created content.

8. The system of claim 1, further comprising:
a database configured to store the brand data, wherein the brand data comprises a plurality of rules for punctuation, grammar, stop words, banned terms, font, style, size of text and editing style parameters used for creating the content.

9. A method of creating a content by an online collaborative system, the method comprising:
executing, by one or more processors, instructions stored in a non-transitory memory to:
receive a plurality of inputs associated with content creation from a plurality of collaborator computing devices and one or more digital data sources;
store collaborator-provided inputs received at different time instances in an asynchronous queue until a completion condition is satisfied;
prior to executing a generative language model, identifying and removing invalid input data using at least one trained machine-learning classifier;
constructing a structured prompt for the generative language model by compiling validated collaborator inputs, contextual metadata, and prior generated content;
executing the generative language model using the structured prompt to generate intermediate content;
enforcing brand-rule constraints on the intermediate content to generate structured output content; and
synchronizing real-time edits from multiple collaborators using a version-controlled collaborative editing process,
wherein eliminating invalid input data prior to language-model execution and constraining language-model inference using the structured prompt improves accuracy and reliability of generated content relative to unconstrained language-model execution.

10. The method of claim 9, further comprising:
identifying invalid data present in the set of inputs; and
eliminating the invalid data prior to integrating the set of inputs into the language model prompt.

11. The method of claim 9, further comprising:
searching for the one or more collaborators, wherein a collaborator has an expertise on the content;
creating suggestions for relevant collaborators based on the content, using one or more embedded models and a vector database;
collecting one or more inputs from the one or more collaborators and the relevant collaborators, wherein the one or more inputs are received at one or more time instances; and
storing the one or more inputs into a queue until all the one or more inputs is collected, wherein the one or more inputs form part of the set of inputs.

12. The method of claim 11, further comprising:
identifying a unique perspective in each of the one or more inputs received form the one or more collaborators;
assigning a weight to the unique perspective; and
analysing the content and the unique perspective of the each of the one or more inputs based on the weight of the unique perspective; and
arriving at a consensus on the unique perspective identified for the each of the one or more inputs, wherein the consensus is used for creating the structured content, and wherein the consensus is independent of an existing consensus on the content present in a public domain.

13. The method of claim 9, further comprising:
tracking changes made by each collaborator;
maintaining a plurality of versions of the created content; and
facilitating a user to revert to a previous version of the created content.

14. The method of claim 9, further comprising:
storing the O data in a repository, wherein the brand data comprises a plurality of rules for punctuation, grammar, stop words, banned terms, font, style, size of text and editing style parameters used for creating the content.

15. The method of claim 9, wherein the one or more inputs are collected in a form of voice memos, video, audio, short text, surveys, chat messages, and questionaries.

16. The method of claim 9, wherein the one or more inputs comprises unique comments, opinions and insights received from the one or more collaborators.

17. The method of claim 9, wherein the one or more data sources comprises the one or more collaborators, and a plurality of digital resources.

18. The method of claim 9, wherein the structured content comprises one or more of marketing materials, blogs, white papers, case studies, shareholder letters, contracts, business collaterals, research articles, and internal documents.
